(19) United States
(12) Patent Application Publication
(10) Pub. No.: US 2019/0220924 A1
(43) Pub. Date: Jul. 18, 2019

(54) METHOD AND DEVICE FOR DETERMINING KEY VARIABLE IN MODEL

(71) Applicant: ALIBABA GROUP HOLDING LIMITED, Grand Cayman (KY)

(72) Inventor: Yan XI, HANGZHOU (CN)

(21) Appl. No.: 16/283,381

(22) Filed: Feb. 22, 2019

Related U.S. Application Data
(63) Continuation of application No. PCT/CN2017/097434, filed on Aug. 15, 2017.

(30) Foreign Application Priority Data
Aug. 26, 2016 (CN) 201610741714.7

(51) Int. Cl. G06Q 40/02; G06K 9/62; G06N 7/00

(52) U.S. Cl. CPC G06Q 40/025; G06K 9/623; G06N 7/00; G06K 9/6215; G06K 9/6212

(57) ABSTRACT

Method, systems, and apparatus, including computer programs encoded on computer storage media for determining a key variable in a model. One of the methods includes: inputting a first sample into a model to obtain a first result, wherein the first sample comprises a plurality of variables; for each of the variables in the first sample, replacing a value of the variable with a threshold corresponding to the variable to obtain a second sample; inputting the second samples into the model, respectively, to obtain a second result set comprising a plurality of second results; and determining, from the plurality of variables, a key variable having the highest impact on the first result based on a difference between the first result and each of the second results in the second result set.

### CROSS-REFERENCE TO RELATED APPLICATIONS

This application is a continuation application of International Patent Application No. PCT/CN2017/097434, filed on Aug. 15, 2017, which is based on and claims priority to the Chinese Patent Application No. 201610741714.7, filed on Aug. 26, 2016 and entitled “Method and Device for Determining Key Variable in Model.” The above-referenced applications are incorporated herein by reference in their entirety.

### TECHNICAL FIELD

This application relates to the field of computer applications, and in particular, to a method and a device for determining a key variable in a model.

### BACKGROUND

In relevant technologies, a large amount of business data from users typically can be collected as modeling samples in a business scenario. The modeling samples are trained using a method of statistical model or machine learning to construct a business model. When the business model construction is completed, business data can be inputted into the business model, and corresponding business prediction can be made in the business scenario according to output results of the business model.

For example, when business data is inputted as a business sample into a business model to obtain a result, however, the model is usually unable to determine which business variable in the business sample has the highest impact on an ultimately outputted business result since the inputted business data typically may contain a number of business variables. Therefore, it is impossible to meet actual business demands.

### SUMMARY

The specification provides a method for determining a key variable in a model, the method comprising:

inputting a first sample into a model to obtain a first result, wherein the first sample comprises a plurality of variables;

for each of the variables in the first sample, replacing a value of the variable with a threshold corresponding to the variable to obtain a second sample;

inputting the second samples into the model, respectively, to obtain a second result set comprising a plurality of second results; and

determining, from the plurality of variables, a key variable having the highest impact on the first result based on a difference between the first result and each of the second results in the second result set.

In some embodiments, the threshold represents a mean, median, or mode of values of its corresponding variable from a target group of users.

In other embodiments, the determining, from the plurality of variables, a key variable having the highest impact on the first result based on a difference between the first result and each of the second results in the second result set comprises: calculating the differences by subtracting the first result from each of the second results in the second result set, respectively; and determining the variable corresponding to a second result having the biggest difference from the first result as the key variable having the highest impact on the first result.

The specification also provides a method for guiding credit improvement, the method comprising: inputting a first sample into a credit evaluation model to obtain a first credit score, wherein the first sample comprises a plurality of variables; for each of the variables in the first sample, replacing a value of the variable with a threshold corresponding to the variable to obtain a second sample; inputting the second samples into the credit evaluation model, respectively, to obtain a second credit score set comprising a plurality of second credit scores; and determining, from the plurality of variables, a key variable having the highest impact on the first credit score based on differences between the first credit score and each of the second credit scores in the second credit score set.

In some embodiments, the threshold represents a mean, median, or mode of values of its corresponding variable from a target group of users.

In other embodiments, the method further comprises: if the first sample comprises a plurality of behavioral variables corresponding to the same behavior, replacing the values of the plurality of behavioral variables with thresholds respectively corresponding to the plurality of behavioral variables to obtain a second sample having the values of the plurality of behavioral variables replaced.

In still other embodiments, the determining, from the plurality of variables, a key variable having the highest impact on the first credit score based on the differences between the first credit score and each of the second credit scores in the second credit score set comprises: calculating the differences by subtracting the first credit score from the each of the second credit scores in the second credit score set, respectively; and determining the variable corresponding to a second credit score having the biggest difference from the first credit score as the key variable having the highest impact on the first credit score. In yet other embodiments, the method further comprises: when the differences obtained by subtracting the first credit score from the each of the second credit scores in the second credit score set, respectively, are all smaller than zero, outputting a preset message to a user corresponding to the first sample, the preset message prompting that a credit risk of the user is controllable.

In other embodiments, the method further comprises: outputting a message corresponding to the key variable to a user corresponding to the first sample as a guide for credit improvement. In still other embodiments, the outputting a message corresponding to the key variable to a user corresponding to the first sample as a guide for credit improvement comprises: determining whether the key variable is a behavioral variable; and if the key variable is a behavioral variable, outputting information of a behavior corresponding to the key variable to the user corresponding to the first sample as a behavior guide.

The specification also provides a device for determining a key variable in a model, the device comprising: one or more processors and one or more non-transitory computer-readable memories coupled to the one or more processors and configured with instructions executable by the one or more processors to cause the device to perform operations comprising:

inputting a first sample into a model to obtain a first result, wherein the first sample comprises a plurality of variables;

for each of the variables in the first sample, replacing a value of the variable with a threshold corresponding to the variable to obtain a second sample;

inputting the second samples into the model, respectively, to obtain a second result set comprising a plurality of second results; and

determining, from the plurality of variables, a key variable having the highest impact on the first result based on a difference between the first result and each of the second results in the second result set.

The specification further provides a device for guiding credit improvement, the device comprising: one or more processors and one or more non-transitory computer-readable memories coupled to the one or more processors and configured with instructions executable by the one or more processors to cause the device to perform operations comprising:

inputting a first sample into a credit evaluation model to obtain a first credit score, wherein the first sample comprises a plurality of variables;

for each of the variables in the first sample, replacing a value of the variable with a threshold corresponding to the variable to obtain a second sample;

inputting the second samples into the credit evaluation model, respectively, to obtain a second credit score set comprising a plurality of second credit scores; and

determining, from the plurality of variables, a key variable having the highest impact on the first credit score based on differences between the first credit score and each of the second credit scores in the second credit score set.

The specification inputs a target sample into a model to obtain a first result, sequentially replaces a value of each of variables in the target sample with a determination threshold corresponding to the variable, inputs target samples with the values of the variables sequentially replaced into the model, respectively, to obtain a second result set, and then determines, on the basis of a difference between the first result and each of second results in the second result set, a key variable having the highest impact on the first result. Therefore, a key variable having the highest impact on the first result can be determined based on the difference between the first result actually obtained through the target sample and the second results obtained through the target sample in the model after the values of the variables are sequentially replaced, and there is no need for an in-depth understanding of the algorithm of the model; and

when the technical solution of the specification is applied in a credit evaluation model, a key variable having the highest impact on the credit score of a user can be determined based on the difference between the credit score actually obtained through the target sample and the credit scores obtained through the target sample in the credit evaluation model after the values of the variables are sequentially replaced, and there is no need for an in-depth understanding of the algorithm of the model. Therefore, the complexity of determining a variable having the highest impact on the credit score can be reduced; meanwhile, by outputting a physical meaning corresponding to the key variable as a guide for credit improvement to a user corresponding to the target sample, the user can intuitively learn about a way to improve his or her own credit, which can therefore improve the user experience.

### BRIEF DESCRIPTION OF THE DRAWINGS

FIG. 1 is a flow chart of a method for determining a key variable in a model according to some embodiments of the specification;

FIG. 2 is a flow chart of a method for guiding credit improvement according to some embodiments of the specification;

FIG. 3 is a flow chart of a process of outputting a guide for credit improvement in a credit evaluation model according to some embodiments of the specification;

FIG. 4 is a logic block diagram of a device for determining a key variable in a model according to some embodiments of the specification;

FIG. 5 is a hardware structural diagram of a server carrying the device for determining a key variable in a model according to some embodiments of the specification;

FIG. 6 is a logic block diagram of a device for guiding credit score improvement according to some embodiments of the specification;

FIG. 7 is a hardware structural diagram of a server carrying the device for guiding credit score improvement according to some embodiments of the specification.

### DETAILED DESCRIPTION

A business risk model is an evaluation model for evaluating business risks. In relevant technologies, a large amount of business data typically can be collected, as modeling samples, in a business scenario, and the modeling samples are classified based on whether the modeling samples contain a pre-defined business risk event. Then, the modeling samples are trained using a method of statistical model or machine learning to construct a business model.

When the business model construction is completed, the collected business data can be inputted, as target samples, into the business risk model for risk evaluation to predict a probability that the business risk event occurs in a future period of time, and then the probability is converted to a corresponding business risk score to reflect a risk level of the business.

As an example, collected business data is inputted, as a target sample, into a constructed evaluation model to obtain a corresponding business risk score, and then it is usually expected that a key variable having the highest impact on the ultimately outputted risk score can be determined from the plurality of variables comprised in the target sample.

In an application scenario of credit business, for example, when the above business risk model is a credit risk evaluation model, a credit bureau inputs business data of a user, as a target sample, into the model for credit evaluation that outputs a credit score of the user. Then, the user usually has a strong desire to improve the credit score; therefore, the credit bureau needs to understand which variable in the business data of the user has the highest impact on the final credit score and which variable lowers the credit score of the user. Based on the credit weaknesses of the user, the credit bureau can then output a pertinent guide for credit improvement to the user.

In relevant technologies, a particular determining algorithm can usually be used to determine a key variable in a target sample having the highest impact on the risk score;

in an application scenario of credit business, for example, a particular algorithm for guiding credit improvement can be designed by going deep inside the modeling algorithm of an evaluation model. A key variable in target samples of a user having the highest impact on the final credit score is determined through the algorithm for guiding credit improvement, and then a business behavior corresponding to the key variable is outputted as a guide for credit improvement to the user.

In the above technical solution, therefore, the design of a determination algorithm typically requires an in-depth understanding of the modeling algorithm of an evaluation model. For conventional modeling algorithms, such as logistic regression algorithm and decision tree algorithm, there is typically no difficulty in designing the above determination algorithm by going deep into these algorithms, as models constructed based on these algorithms have characteristics of conciseness in structure and high interpretability.

With the development of big data mining technologies and the improvement of computation performance of computers, however, more and more complex algorithms have been applied in evaluation models, such as GBDT (Gradient Boosting Decision Tree, which is an iterative decision tree algorithm), deep neural network, and the like. Since models generated based on these complex algorithms are not easy to be interpreted, a consequent issue is that, when designing the above determination algorithm, it is usually difficult to go deep inside the algorithm of the model, and there will be difficulties in designing the above determination algorithm.

In view of this, particular embodiments inputs a target sample into a model to obtain a first result, sequentially replaces a value of each of variables in the target sample with a determination threshold corresponding to the variable, inputs target samples with the values of the variables sequentially replaced into the model, respectively, to obtain a second result set, and then determines, on the basis of a difference between the first result and each of second results in the second result set, a key variable having the highest impact on the first result. Therefore, a key variable having the highest impact on the first result can be determined based on the difference between the first result actually obtained through the target sample and the second results obtained through the target sample in the model after the values of the variables are sequentially replaced, and there is no need for an in-depth understanding of the algorithm of the model; and

when the technical solution of the specification is applied in a credit evaluation model, a key variable having the highest impact on the credit score of a user can be determined based on the difference between the credit score actually obtained through the target sample and the credit scores obtained through the target sample in the credit evaluation model after the values of the variables are sequentially replaced, and there is no need for an in-depth understanding of the algorithm of the model. Therefore, the complexity of determining a variable having the highest impact on the credit score can be reduced; meanwhile, by outputting a physical meaning corresponding to the key variable as a guide for credit improvement to a user corresponding to the target sample, the user can intuitively learn about a way to improve his/her own credit, which can therefore improve the user experience.

Descriptions are provided below with reference to embodiments and examples of application scenarios.

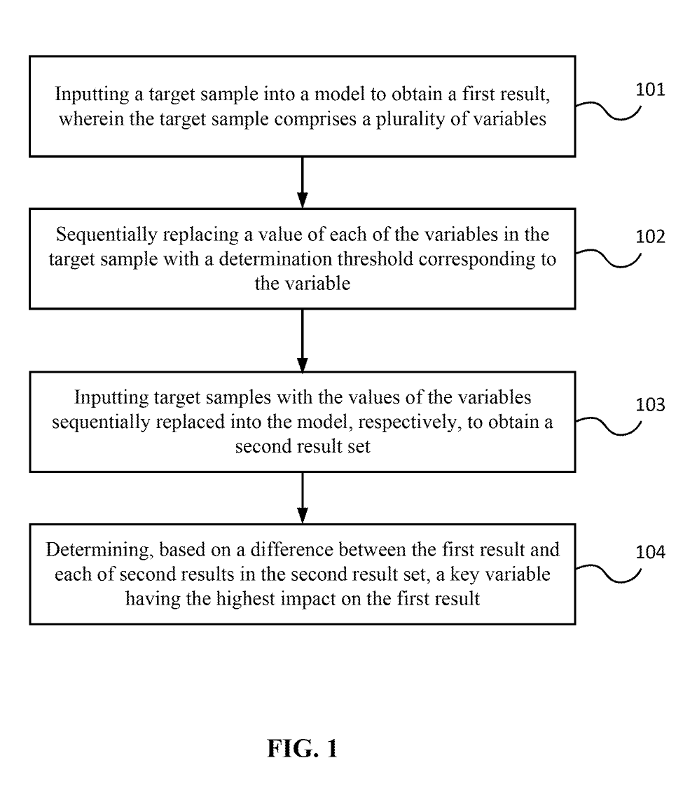

Referring to FIG. 1, FIG. 1 is a flow chart of a method for determining a key variable in a model according to some embodiments of the specification. The method is applied to a server and implements the following steps:

Step 101, inputting a target sample into a model to obtain a first result, wherein the target sample comprises a plurality of variables;

Step 102, sequentially replacing a value of each of the variables in the target sample with a determination threshold corresponding to the variable;

Step 103, inputting target samples with the values of the variables sequentially replaced into the model, respectively, to obtain a second result set; and

Step 104, determining, on the basis of a difference between the first result and each of second results in the second result set, a key variable having the highest impact on the first result.

The server above can comprise a server, a server cluster, or a cloud platform constructed based on a server cluster for training and using a business model.

The model above can comprise a math model for business prediction that is constructed by training a large amount of collected modeling samples based on a preset modeling algorithm. For example, the business model above can be an evaluation model. With the model, the business risk of a user in a future period of time can be scored and the scoring result can be outputted.

Here, the process of constructing a model based on training a large amount of collected modeling samples will not be described in detail in the specification. A person skilled in the art may refer to relevant technologies; when training the above model, for example, the server can use a modeling method, such as scorecard, regression analysis, or neural network, use a mature data mining tool, such as SAS (Statistical Analysis System) and SPSS (Statistical Product and Service Solutions), and construct the above business model through training a large amount of collected modeling samples.

In the present example, when the training of the above business model is completed, the server can collect target samples of a target user. Here, a plurality of business variables can be comprised in business data used as the target samples and the modeling samples, while these business variables can further comprise a plurality of behavioral variables. For example, when the business model is an evaluation model, variables comprised in the target samples and modeling samples can be variables having an impact on the business, while these variables can further comprise business variables corresponding to the user's business behaviors.

In some embodiments, the number of behavioral variables comprised in the target samples and modeling samples can be user-defined based on actual needs. For example, variables in the target samples can all be defined to be behavioral variables so as to determine a user behavior having the highest impact on output results of the business model.

After collecting a target sample of the target user, the server can input the target sample into the trained evaluation model for business prediction to obtain a first result corresponding to the target sample.

After the first result is obtained by inputting the target sample into the model for business prediction, the server can sequentially replace a value of each of the variables in the business sample with a determination threshold corresponding to the variable, and then input the target sample with the values of the variables sequentially replaced into the business model, respectively, for business prediction, so as to determine a variable in the target sample having the highest impact on the first result.

The determination threshold can be a threshold capable of representing the overall level of values of variables comprised in the collected target sample in the group of target users, wherein all variables comprised in the target sample can respectively correspond to a determination threshold used to replace the value of each of the variables.

The group of target users can be defined as all groups who conduct businesses corresponding to the target sample, or can be defined as a particular business group to which a target user corresponding to the target sample belongs, which is not particularly limited in the present example.

In an illustrated implementation manner, the determination threshold can be defined as any one of mean, median, and mode of values of a corresponding business variable in the group of target users. Here, the mean, median, and mode are all basic statistical concepts. Mean refers to an average found by adding all value samples and dividing by the number of the value samples. Median refers to a middle number found by ordering all value samples and finding the one in the middle, or taking the mean of the two middle numbers. Mode refers to a value of the value sample that occurs the highest number of times in all value samples.

In this way, a determination threshold can be set for variables in the target sample, respectively, by using corresponding values of the variables in the target sample in the group of target users as value samples to perform simple statistical analysis and computation.

Here, when mode is used as the determination threshold, there may be a plurality of modes. In this case, an average of the plurality of modes or any one of the plurality of modes can be used as the determination threshold.

In the present example, when a value of each of the variables in the target sample is sequentially replaced with a determination threshold corresponding to the variable, the variables in the target sample can typically be replaced one by one with a determination threshold corresponding to each of the variables.

In some embodiments, however, the target sample may comprise a plurality of behavioral variables corresponding to the same behavior; in this case, if the target sample comprises a plurality of behavioral variables corresponding to the same behavior, the values of the plurality of behavioral variables can be simultaneously replaced with the determination thresholds respectively corresponding to the plurality of behavioral variables.

In the present example, after a value of each of the variables in the target sample is sequentially replaced with a determination threshold corresponding to the variable, the plurality of target samples obtained from the sequential replacement of values of the variables can be further inputted, respectively, into the business model for business prediction to obtain a second result set.

In the present example, moreover, after the plurality of target samples obtained from the sequential replacement of values of the variables are inputted, respectively, into the business model for business prediction, the server can store a corresponding relationship between the variables with values replaced and business credit scores obtained by inputting the target samples into the business model after the values of the variables are replaced.

In this manner, the server can subsequently locate a corresponding business variable with the value replaced through querying the corresponding relationship based on any second result in the second result set.

In the present example, when determining a key variable having the highest impact on the first result, the server can compare values of the obtained first result and each second result in the second result set, calculate a difference between the first result and each second result in the second result set, and then determine a key variable having the highest impact on the first result based on the calculated differences.

In an illustrated implementation manner, the server can calculate a difference by subtracting the first result from each second result in the second result set, respectively. When determining a variable having the highest impact on the first result, the server can determine the second result in the second result set having the biggest difference with respect to the first result as the key result. After determining the key result, the server can use the key result as a query index to determine a variable with the value replaced corresponding to the key result according to the pre-stored corresponding relationship. The variable having the corresponding relationship with the key result that is determined at this point is the ultimately determined key variable having the highest impact on the first result.

In this manner, therefore, a key business variable having the highest impact on the first result can be determined quickly and simply by comparing the differences between the results obtained through the target sample in the model after sequential replacement of values of the variables and the actual result obtained through the target sample without variable value replacement. There is no need for an in-depth understanding of the algorithm of the model, and therefore, the complexity of determining a variable having the highest impact on the first result can be reduced.

In some embodiments, the business model can be a credit evaluation model. The description below uses an example in which the business model is a credit evaluation model.

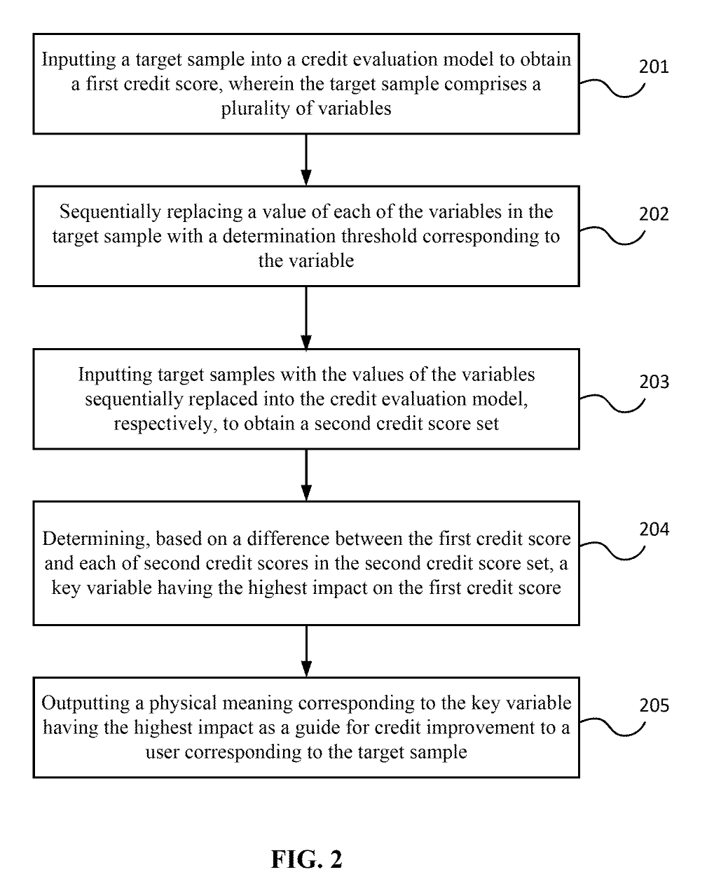

Referring to FIG. 2, FIG. 2 is a flow chart of a method for guiding credit improvement according to some embodiments of the specification. The method is applied to a server and implements the following steps:

Step 201, inputting a target sample into a credit evaluation model to obtain a first credit score, wherein the target sample comprises a plurality of variables;

the server above can comprise a server, a server cluster, or a cloud platform constructed based on a server cluster for training and using a credit evaluation model.

The credit evaluation model above can comprise a math model for credit evaluation that is constructed by training a large amount of collected modeling samples based on a preset modeling algorithm. For example, the credit evaluation model above can be a credit risk evaluation model. With the model, the credit risk of a user can be scored and the scoring result can be outputted.

The credit score is a credit score obtained after the credit evaluation performed by the credit evaluation model on the collected target sample. The credit score is used to measure credit risk of the user in a future period of time.

In a scenario of credit business, for example, the credit evaluation model can perform credit risk evaluation on business data collected from a particular scenario of credit business to obtain a corresponding credit score, and the credit score is used to measure the probability of credit default by the user in a future period of time.

Here, the process of constructing a credit evaluation model based on training a large amount of collected modeling samples will not be described in detail in the specification. A person skilled in the art may refer to relevant technologies; when training the above credit evaluation model, for example, the server can use a modeling method, such as scorecard, regression analysis, or neural network, use a mature data mining tool, such as SAS (Statistical Analysis System) and SPSS (Statistical Product and Service Solutions), and construct the above credit evaluation model through training a large amount of collected modeling samples.

In the present example, when the training of the above credit evaluation model is completed, the server can collect target samples of a target user. The target user is a user on whom credit risk evaluation will be performed. The modeling samples and the target samples can both comprise business data collected from a particular business scenario. The business data, as modeling samples, can be used to train the model, while the business data, as target samples, can be used for evaluating credit risk of a target user.

Here, a plurality of business variables can be comprised in business data used as the target samples and the modeling samples, while these business variables can further comprise a plurality of behavioral variables.

For example, in a scenario of credit business, variables comprised in the target samples and the modeling samples can be variables having an impact on credit risk, including variables having an impact on credit risk such as a user's income and consumption data, historical credit data, default data, employment situation of a user, and the like. Among these variables, income and consumption data, historical credit data, and default data respectively correspond to the user's consumption behavior, credit behavior, and default behavior. Therefore, income and consumption data, historical credit data, and default data can be referred to as behavioral variables in the target samples.

In some embodiments, the number of behavioral variables comprised in the target samples and modeling samples can be user-defined based on actual needs. For example, variables in the target samples can all be defined to be behavioral variables so as to determine a user behavior having the highest impact on credit score.

After collecting a target sample of the target user, the server can input the target sample into the trained credit evaluation model for risk evaluation to obtain a first credit score corresponding to the target sample.

S202, sequentially replacing a value of each of the variables in the target sample with a determination threshold corresponding to the variable;

S203, inputting target samples with the values of the variables sequentially replaced into the credit evaluation model, respectively, to obtain a second credit score set;

after the first credit score is obtained by inputting the target sample into the model for credit risk evaluation, the server can sequentially replace a value of each of the variables in the business sample with a determination threshold corresponding to the variable, and then input the target sample with the values of the variables sequentially replaced into the credit evaluation model, respectively, for credit risk evaluation, so as to determine a variable in the target sample having the highest impact on the first credit score.

The determination threshold can be a threshold capable of representing the overall level of values of variables comprised in the collected target sample in the group of target users, wherein all variables comprised in the target sample can respectively correspond to a determination threshold used to replace the value of each of the variables.

The group of target users can be defined as all groups who conduct businesses corresponding to the target sample, or can be defined as a particular business group to which a target user corresponding to the target sample belongs, which is not particularly limited in the present example.

In an illustrated implementation manner, the determination threshold can be defined as any one of mean, median, and mode of values of a corresponding business variable in the group of target users.

In relevant technologies, when measuring the overall level of a value of a variable in a group of target users, values of all users in the group of target users corresponding to the variable can typically be collected as value samples, then mean, median, or mode of all the collected value samples are calculated, and any one of the mean, median, and mode is used to represent the overall level of the value of the variable in a group of target users.

For example, in a scenario of credit business, the target sample can comprise business variables such as income and consumption data, historical credit data, default data, employment situation of a user, and the like. Assuming that it is necessary to determine the overall level of the business variable of income and consumption data in a group of target users, income and consumption data of all users in the group of target users can be collected as value samples, then the mean, median, or mode of detailed consumption amounts corresponding to the collected income and consumption data of all users are calculated, and any one of the mean, median, and mode is used as the overall level in the group of target users.

Here, the mean, median, and mode are all basic concepts in statistics.

Mean refers to an average obtained by adding all value samples and dividing by the number of the value samples.

Median refers to a middle number obtained by ordering all value samples and finding the one in the middle, or taking the mean of the two middle numbers.

Mode refers to a value of the value sample that occurs the highest number of times in all value samples.

For example, therefore, any one of mean, median, and mode of values of variables of the target sample in the group of target users can be directly set as the determination threshold. In this way, a determination threshold can be set for variables in the target sample, respectively, by using corresponding values of the variables in the target sample in the group of target users as value samples to perform simple statistical analysis and computation.

Here, when mode is used as the determination threshold, there may be a plurality of modes. In this case, an average of the plurality of modes or any one of the plurality of modes can be used as the determination threshold.

In another illustrated implementation manner, the determination threshold can be further defined as a threshold capable of representing the overall level of values of variables of the target sample in the group of target users and obtained by statistical analysis, through a particular statistical analysis algorithm, on value samples of variables of the target sample in the group of target users.

The mean, median, or mode of values of business variables of the target sample in the group of target users usually cannot accurately reflect the overall level of values of the business variables in the group of target users.

As an example, therefore, any one of mean, median, and mode of values of variables of the target sample in the group of target users can be defined as the determination threshold. In addition, when measuring the overall level of a value of a variable in a group of target users, values of all users in the group of target users corresponding to the variable can also be used as value samples for statistical analysis, through a particular statistical analysis algorithm, to obtain a threshold capable of representing the overall level of values of the variable of the target sample in the group of target users, and then the obtained threshold is defined as the determination threshold.

Here, the statistical analysis algorithm used for statistical analysis on the value samples can be the same as or different from the algorithm used to construct the evaluation model.

For example, an algorithm such as regression analysis and a mature data mining tool, such as SAS or SPSS, can be used to perform statistical analysis on the value samples to obtain a value distribution pattern of all the value samples, then a value capable of representing the overall level of values of the variable in the group of target users is determined based on the value distribution pattern. The process of statistical analysis will not be described in detail in the present example, and a person skilled in the art may refer to relevant technologies during implementation.

In addition to the methods for defining the determination threshold described above, other mathematical quantification methods can also be used to define a determination threshold for business variables in the target sample, respectively.

In some embodiments, regardless of mathematical quantification methods used, the determination threshold ultimately defined for business variables in the target sample, respectively, is intended to represent the overall level of values of the variable in the group of target users, which will not be listed one by one in the present example.

In the present example, when a value of each of the variables in the target sample is sequentially replaced with a determination threshold corresponding to the variable, the variables in the target sample can typically be replaced one by one with a determination threshold corresponding to each of the variables.

For example, assuming that the target sample comprises three variables V1, V2, and V3, and the determination thresholds corresponding to V1, V2, and V3 are V1-t, V2-t, and V3-t, respectively, then V1-t can be used first to replace the value of the variable V1 to obtain a target sample comprising V1-t, V2, and V3. Next, V2-t is used to replace the value of the variable V2 to obtain a target sample comprising V1, V2-t, and V3. Lastly, V3-t is used to replace the value of the variable V3 to obtain a target sample comprising V1, V2, and V3-t.

As an example, however, the target sample may comprise a plurality of behavioral variables corresponding to the same behavior.

For example, in a scenario of credit business, assuming that the target sample simultaneously comprises variables such as “default amount,” “default times,” “income and consumption data,” and the like, the variable “income and consumption data” uniquely corresponds to a user's consumption behavior; while the variables “default amount” and “default times” both correspond to a user's default behavior. In this case, the variables “default amount” and “default times” are behavioral variables in the target sample that correspond to the same behavior.

In the present example, if the target sample comprises a plurality of behavioral variables corresponding to the same behavior, the values of the plurality of behavioral variables can be simultaneously replaced with the determination thresholds respectively corresponding to the plurality of behavioral variables.

For example, assuming that the target sample comprises three variables V1, V2, and V3, and the determination thresholds corresponding to V1, V2, and V3 are V1-t, V2-t, and V3-t, respectively. Here, V2 and V3 correspond to the same behavior. Then, V1-t can be used first to replace the value of the variable V1 to obtain a target sample comprising V1-t, V2, and V3. Next, V2-t and V3-t are used simultaneously to replace the values of the variables V2 and V3 to obtain a target sample comprising V1, V2-t, and V3-t.

In the present example, after a value of each of the variables in the target sample is sequentially replaced with a determination threshold corresponding to the variable, the plurality of target samples obtained from the sequential replacement of values of the variables can be further inputted, respectively, into the credit evaluation model for credit risk evaluation to obtain a second credit score set.

For example, assuming that the target sample comprises three variables V1, V2, and V3, and the determination thresholds corresponding to V1, V2, and V3 are V1-t, V2-t, and V3-t, respectively. After the values of the variables V1, V2, and V3 are sequentially replaced with V1-t, V2-t, and V3-t, a target sample comprising V1-t, V2, and V3, a target sample comprising V1, V2-t, and V3, and a target sample comprising V1, V2, and V3-t can be obtained. In this case, the three target samples can be inputted, respectively, into the credit evaluation model for credit risk evaluation to obtain a second credit score set that comprises three credit scores.

In the present example, moreover, after the plurality of target samples obtained from the sequential replacement of values of the variables are inputted, respectively, into the credit evaluation model for credit risk evaluation, the server can store a corresponding relationship between the variables with values replaced and credits scores obtained by inputting the target samples into the evaluation model after the values of the variables are replaced.

In this manner, the server can subsequently locate a corresponding business variable with the value replaced through querying the corresponding relationship based on any credit score in the second credit score set.

S204, determining, on the basis of a difference between the first credit score and each of second credit scores in the second credit score set, a key variable having the highest impact on the first credit score.

In the present example, when determining a key variable having the highest impact on the first credit score, the server can compare values of the obtained first credit score and each credit score in the second credit score set, calculate a difference between the first credit score and each credit score in the second credit score set, and then determine a key variable having the highest impact on the first credit score based on the calculated differences.

In an illustrated implementation manner, the server can calculate a difference by subtracting the first credit score from each credit score in the second credit score set, respectively. Here, the calculated difference may be greater than zero “0” or may be smaller than 0.

If the calculated difference is greater than 0, it indicates that the credit score obtained by inputting the target sample into the model after a value of one variable is replaced with the corresponding determination threshold is greater than the credit score obtained by the target sample in the model without value replacement. In this case, the increase of the credit score is probably caused by the variable whose value is replaced.

If the calculated difference is smaller than 0, it indicates that the credit score obtained by inputting the target sample into the model after a value of one variable is replaced with the corresponding determination threshold is smaller than the credit score obtained by the target sample in the model without value replacement. In this case, the variable whose value is replaced probably lowers the credit score.

Since a credit score is typically in inverse proportion to a risk level, higher credit score means lower corresponding risk.

In this case, therefore, when determining a variable having the highest impact on the first credit score, the credit score in the second credit score set having the biggest difference from the first credit score can be determined as the key credit score.

After determining the key credit score, the server can use the credit score as a query index to determine a variable with the value replaced corresponding to the credit score according to the pre-stored corresponding relationship. The variable having the corresponding relationship with the key credit score that is determined at this point is the ultimately determined key variable having the highest impact on the first credit score.

For example, if a credit score obtained by inputting the target sample into the model after one variable is replaced has the biggest difference from the first credit score, it indicates that after the value of the variable is replaced with the overall level of the variable in the group of target users, the ultimately obtained credit score is significantly increased and the risk is significantly decreased, compared with other replaced variables.

In this case, the user's risk is relatively high when the variable is not replaced, which is in fact because the variable lowers the first credit score, indicating that the performance of the target user corresponding to the target sample on this variable is below the overall level of the group of target users. Therefore, it is reasonable to determine the variable as the key business variable in this situation.

S205, outputting a physical meaning corresponding to the key variable having the highest impact as a guide for credit improvement to the user corresponding to the target sample.

After determining the key variable having the highest impact on the first credit score, the physical meaning corresponding to the key variable can be further outputted as a guide for credit improvement to the target user corresponding to the target sample.

In an illustrated implementation manner, the physical meaning corresponding to the key variable can be a user behavior corresponding to the key variable. After determining the key variable in the manner illustrated above, the server can further determine whether the key variable is a behavioral variable. If the key variable is a behavioral variable, the server can further output the behavior corresponding to the key variable as a behavior guide to the target user corresponding to the target sample.

In this case, the target user can learn, through the outputted behavior guide, about what behavior probably increases his or her own risk and lowers the credit score. Subsequently, the target user can lower his or her own risk and increase the credit score by improving the behavior.

For example, in a scenario of credit business, assuming that the key variable is the variable of default times in the target sample and the business behavior corresponding to the key variable is a default behavior, the system can output a guide for credit improvement, “avoid too many times of default so as to increase the credit score,” to the user. Upon viewing the guide for credit improvement outputted by the system, the user with a relatively low credit score can pay attention to his or her own performance behavior in the future in a pertinent manner by making payments on time as much as possible and reducing default records to improve his or her own credit score.

In this manner, therefore, a key business variable having the highest impact on the credit score can be determined quickly and simply by comparing the differences between the credit scores obtained through the target sample in the model after sequential replacement of values of the variables and the actual credit score obtained through the target sample. There is no need for an in-depth understanding of the algorithm of the model, and therefore, the complexity of determining a variable having the highest impact on the credit score can be reduced.

By outputting a guide for credit improvement to the user, meanwhile, the user can intuitively learn about “weaknesses” of his or her own credit, and then can improve his or her own credit level by mitigating the credit weaknesses.

In the present example, if the difference between each credit score in the second credit score set and the first credit score is always smaller than 0, it indicates that the target user corresponding to the target sample has better performance on every variable comprised in the target sample than the overall level of the group of target users since a credit score is in inverse proportion to a risk level (i.e., when the value is replaced with the overall level, the risk increases).

In this situation, therefore, there is no need to output the guide for credit improvement, but to output a preset prompt message to the target user; the prompt message is used to prompt that the credit risk of the target user is controllable; for example, when the credit score is a credit score obtained by the credit risk evaluation model, the prompt message can be a prompt message, “your credit record is excellent.”

As an example, if a credit score defined by an evaluation model is in direct proportion to a risk level, i.e., higher credit score means higher corresponding risk, the implementation process for determining a key variable having the highest impact on the first credit score is reverse to the implementation process illustrated above.

In this situation, when determining a key variable having the highest impact on the first credit score, a difference can be calculated by subtracting each credit score in the second credit score set from the first credit score, the credit score in the second credit score set having the biggest difference from the first credit score is determined as the key credit score, and a key variable having the highest impact on the first credit score is determined by querying the corresponding relationship.

The technical solution in the embodiment above will be described in detail with reference to examples.

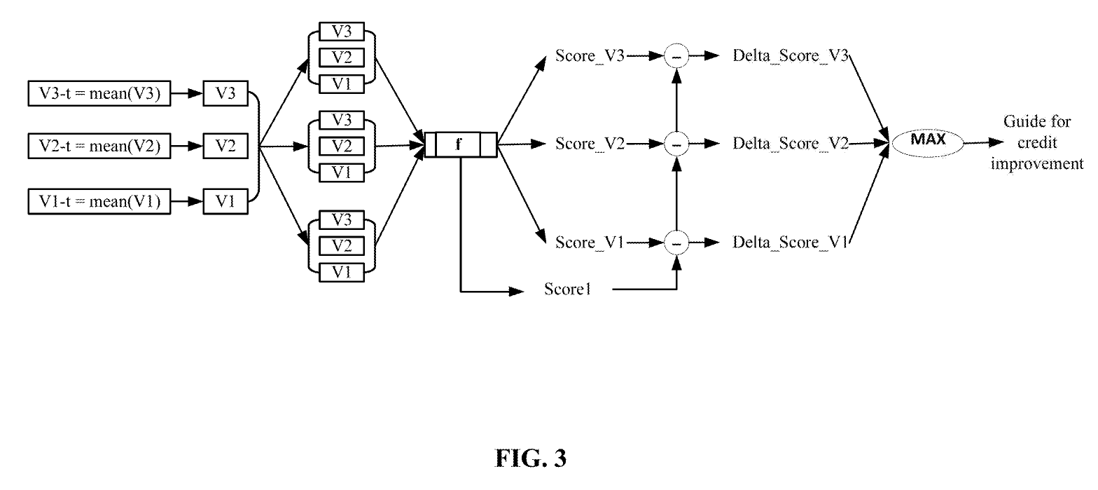

Referring to FIG. 3, FIG. 3 is a flow chart of a process of outputting a guide for credit improvement in a credit evaluation model according to some embodiments of the specification.

As shown in FIG. 3, the credit risk evaluation model comprises three business variables V1, V2, and V3, wherein V1, V2, and V3 are all behavioral variables, and the determination thresholds corresponding to V1, V2, and V3 are V1-t, V2-t, and V3-t, respectively.

V1-t, V2-t, and V3-t are the mean of V1, V2, and V3 in the group of target users, respectively (it is shown in FIG. 3 that a mean function is used to find the mean of V1, V2, and V3 in the group of target users to obtain V1-t, V2-t, and V3-t).

In the initial state, after collecting a target sample of the target user, the server can input the target sample into the model for credit evaluation to obtain a credit score, which is recorded as Score1.

To determine a key business variable having the highest impact on Score1, the values of V1, V2, and V3 can be sequentially replaced with the corresponding determination thresholds.

First, V1-t can be used to replace the value of the business variable V1 to obtain a target sample comprising V1-t, V2, and V3.

Next, V2-t is used to replace the value of the business variable V2 to obtain a target sample comprising V1, V2-t, and V3.

Lastly, V3-t is used to replace the value of the business variable V3 to obtain a target sample comprising V1, V2, and V3-t.

After the replacement is completed, the three target samples obtained above, i.e., the target sample comprising V1-t, V2, and V3, the target sample comprising V1, V2-t, and V3, and the target sample comprising V1, V2, and V3-t, can be inputted, respectively, into the model for credit risk evaluation to obtain a credit score. Here, in the present example, higher credit score means higher credit level of the target user and lower default probability.

Assume that:

the credit score obtained by the target sample comprising V1-t, V2, and V3 in the model is recorded as Score_V1. The server can store a corresponding relationship between V1 and Score_V1;

the credit score obtained by the target sample comprising V1, V2-t, and V3 in the model is recorded as Score_V2. The server can store a corresponding relationship between V2 and Score_V2; and

the credit score obtained by the target sample comprising V1, V2, and V3-t in the model is recorded as Score_V3. The server can store a corresponding relationship between V3 and Score_V3.

When outputting a guide for credit improvement, the server can calculate a difference by subtracting Score1 from Score_V1, Score_V2, and Score_V3, respectively.

The difference between Score_V1 and Score1 is recorded as delta_Score_V1.

The difference between Score_V2 and Score1 is recorded as delta_Score_V2.

The difference between Score_V3 and Score1 is recorded as delta_Score_V3.

Then, the credit score having the biggest difference from Score1 is determined as the key score, and the corresponding relationship is queried to determine a business variable corresponding to the key score as the key variable. At this point, the business behavior corresponding to the key variable is the guide for credit improvement to be outputted.

Assuming that delta_Score_V1 between Score_V1 and Score1 is determined to be the biggest, then the server can query the corresponding relationship to determine the business variable V1 corresponding to Score_V1 as the key variable having the highest impact on the credit score Score1, and output the business behavior corresponding to the business variable V1 as the key business variable V1 to the user.

For example, if the business behavior corresponding to the business variable V1 is a default behavior, the system can output a guide for credit improvement, “avoid too many times of default so as to increase the credit score,” to the user. Upon viewing the guide for credit improvement outputted by the system, the target user can pay attention to his or her own performance behavior in the future in a pertinent manner by making payments on time as much as possible and reducing default records to improve his or her credit score Score1.

If the differences between Score_V1, Score_V2, and Score_V3 and Score1 are all smaller than 0, it indicates that the target user has better performance on business behaviors corresponding to V1, V2, and V3 than the overall level of the group of target users. In this situation, there is no need to output the behavior guide; alternatively, the system can output a prompt message to the user for prompting that the current credit record of the target user is excellent.

From the embodiments above, it can be seen that particular embodiments input a target sample into a model to obtain a first result, sequentially replace a value of each of variables in the target sample with a determination threshold corresponding to the variable, input target samples with the values of the variables sequentially replaced into the model, respectively, to obtain a second result set, and then determine, on the basis of a difference between the first result and each of second results in the second result set, a key variable having the highest impact on the first result. Therefore, a key variable having the highest impact on the first result can be determined based on the difference between the first result actually obtained through the target sample and the second results obtained through the target sample in the model after the values of the variables are sequentially replaced, and there is no need for an in-depth understanding of the algorithm of the model; and when the technical solution of the specification is applied in a credit evaluation model, a key variable having the highest impact on the credit score of a user can be determined based on the difference between the credit score actually obtained through the target sample and the credit scores obtained through the target sample in the credit evaluation model after the values of the variables are sequentially replaced, and there is no need for an in-depth understanding of the algorithm of the model. Therefore, the complexity of determining a variable having the highest impact on the credit score can be reduced; meanwhile, by outputting a physical meaning corresponding to the key variable as a guide for credit improvement to a user corresponding to the target sample, the user can intuitively learn about a way to improve his or her own credit, which can therefore improve the user experience.

Corresponding to the method embodiment, the specification further provides a device embodiment.

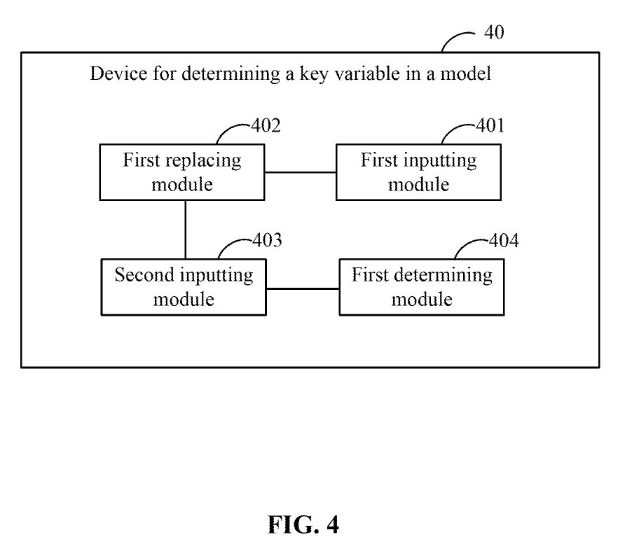

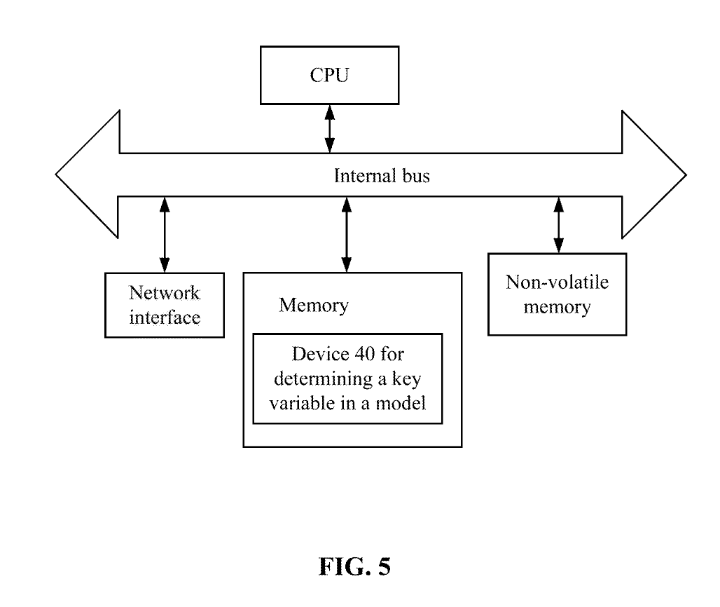

Referring to FIG. 4, the specification provides a device 40 for determining a key variable in a model, which is applied on a server, wherein, referring to FIG. 5, the hardware architecture of the server carrying the device 40 for determining a key variable in the model typically comprises CPU, a memory, a non-volatile memory, a network interface, and an internal bus; with software implementation as an example, the device 40 for determining a key variable in the model can typically be construed as a logic device that combines software and hardware formed after a computer program loaded in the memory is executed by CPU. The device 40 comprises:

a first inputting module 401 configured to input a target sample into a model to obtain a first result, wherein the target sample comprises a plurality of variables;

a first replacing module 402 configured to sequentially replace a value of each of the variables in the target sample with a determination threshold corresponding to the variable;

a second inputting module 403 configured to input the target sample with the values of the variables sequentially replaced into the model, respectively, to obtain a second result set; and

a first determining module 404 configured to determine, on the basis of a difference between the first result and each of second results in the second result set, a key variable having the highest impact on the first result.

In the present example, the determination threshold represents the overall level of values of its corresponding variable in the target group of users;

wherein the determination threshold is the mean, median, or mode of values of its corresponding variable in the target group of users.

In the present example, the first replacing module 402 is configured to:

calculate a difference by subtracting the first result from each second result in the second result set, respectively; and

determine the variable with the value replaced corresponding to the second result corresponding to the biggest difference as the key variable having the highest impact on the first result.

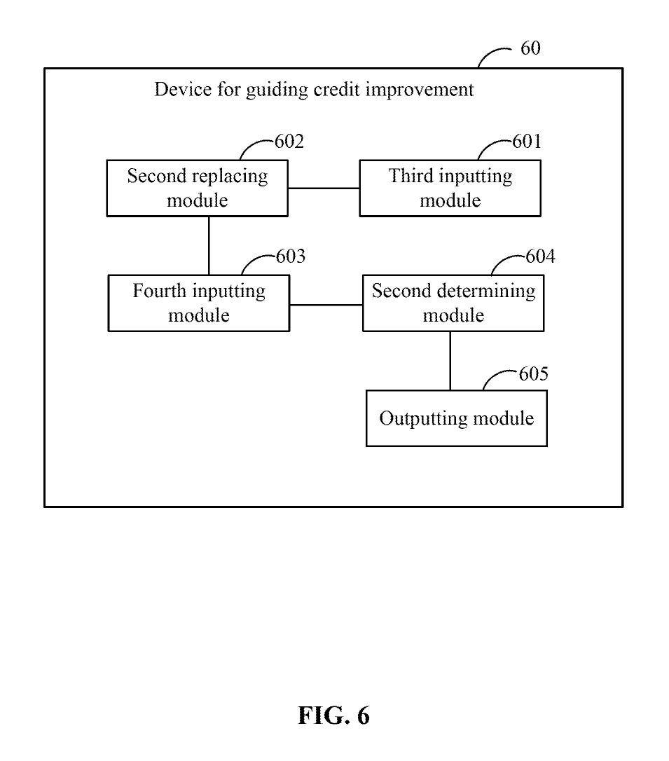

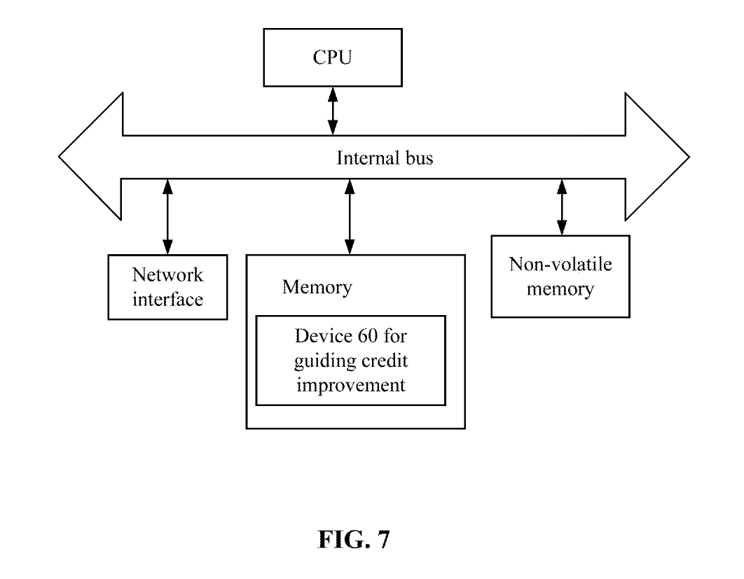

Referring to FIG. 6, the specification provides a device 60 for guiding credit score improvement, which is applied on a server, wherein, referring to FIG. 7, the hardware architecture of the server carrying the device 60 for guiding credit score improvement typically comprises CPU, a memory, a non-volatile memory, a network interface, and an internal bus; with software implementation as an example, the device 60 for determining a key variable in the evaluation model can typically be construed as a logic device that combines software and hardware formed after a computer program loaded in the memory is executed by CPU. The device 60 comprises:

a third inputting module 601 configured to input a target sample into a credit evaluation model to obtain a first credit score, wherein the target sample comprises a plurality of variables;

a second replacing module 602 configured to sequentially replace a value of each of the variables in the target sample with a determination threshold corresponding to the variable;

a fourth inputting module 603 configured to input the target samples with the values of the variables sequentially replaced into the credit evaluation model, respectively, to obtain a second credit score set;

a second determining module 604 configured to determine, on the basis of a difference between the first credit score and each of second credit scores in the second credit score set, a key variable having the highest impact on the first credit score; and

an outputting module 605 configured to output a physical meaning corresponding to the key variable having the highest impact as a guide for credit improvement to a user corresponding to the target sample.

In the present example, the determination threshold represents the overall level of values of its corresponding variable in the target group of users; wherein the determination threshold is the mean, median, or mode of values of its corresponding variable in the target group of users.

In the present example, the second replacing module 602 is further configured to:

if the target sample comprises a plurality of behavioral sub-variables corresponding to the same behavior variable, replace values of the plurality of behavioral sub-variables simultaneously with the determination thresholds respectively corresponding to the plurality of behavioral sub-variables.

In the present example, the second determining module 604 is further configured to:

calculate a difference by subtracting the first credit score from each second credit score in the second credit score set, respectively; and

determine the variable with the value replaced corresponding to the second credit score corresponding to the biggest difference as the key variable having the highest impact on the first credit score.

In the present example, the outputting module 605 is further configured to:

determine whether the key variable is a behavioral variable; and if the key variable is a behavioral variable, output a behavior corresponding to the key variable as a behavior guide to the target user corresponding to the target sample.

In the present example, the outputting module 605 is further configured to:

when the difference obtained by subtracting the first credit score from each second credit score in the second credit score set, respectively, is always smaller than 0, output a preset prompt message; the prompt message prompting that the credit risk of the target user corresponding to the target sample is controllable.

After considering the specification and implementing the invention disclosed herein, a person skilled in the art can easily conceive of other implementation solutions of the specification. The specification is intended to cover all variations, uses or adaptive changes of the specification, and these variations, uses or adaptive changes follow general principles of the specification and comprise common general knowledge or common technical means in the art that are not disclosed by the specification. The specification and embodiments are only regarded as illustrative, and the true scope of spirit of the specification are subject to the appended claims.

It should be understood that the specification is not limited to the precise structure described above and illustrated in the accompanying drawings, and various modifications and changes can be made to the specification without departing from the scope thereof. The scope of the specification is only limited by the appended claims.

Only preferred embodiments of this application are described above, which are not used to limit this application. Any modification, equivalent substitution or improvement made within the spirit and principle of this application shall be encompassed by the protection scope of this application.

What is claimed is:

1. A method for determining a key variable in a model, the method comprising:
inputting a first sample into a model to obtain a first result, wherein the first sample comprises a plurality of variables;
for each of the variables in the first sample, replacing a value of the variable with a threshold corresponding to the variable to obtain a second sample;
inputting the second samples into the model, respectively, to obtain a second result set comprising a plurality of second results; and
determining, from the plurality of variables, a key variable having the highest impact on the first result based on a difference between the first result and each of the second results in the second result set.

2. The method according to claim 1, wherein the threshold represents a mean, median, or mode of values of its corresponding variable from a target group of users.

3. The method according to claim 1, wherein the determining, from the plurality of variables, a key variable having the highest impact on the first result based on a difference between the first result and each of the second results in the second result set comprises:
calculating the differences by subtracting the first result from each of the second results in the second result set, respectively; and
determining the variable corresponding to a second result having the biggest difference from the first result as the key variable having the highest impact on the first result.

4. A method for guiding credit improvement, the method comprising:
inputting a first sample into a credit evaluation model to obtain a first credit score, wherein the first sample comprises a plurality of variables;
for each of the variables in the first sample, replacing a value of the variable with a threshold corresponding to the variable to obtain a second sample;
inputting the second samples into the credit evaluation model, respectively, to obtain a second credit score set comprising a plurality of second credit scores; and
determining, from the plurality of variables, a key variable having the highest impact on the first credit score based on a difference between the first credit score and each of the second credit scores in the second credit score set.

5. The method according to claim 4, wherein the threshold represents a mean, median, or mode of values of its corresponding variable from a target group of users.

6. The method according to claim 4, further comprising: if the first sample comprises a plurality of behavioral variables corresponding to the same behavior, replacing the values of the plurality of behavioral variables with thresholds respectively corresponding to the plurality of behavioral variables to obtain a second sample having the values of the plurality of behavioral variables replaced.

7. The method according to claim 4, wherein the determining, from the plurality of variables, a key variable having the highest impact on the first credit score based on a difference between the first credit score and each of the second credit scores in the second credit score set comprises:
calculating the differences by subtracting the first credit score from the each of the second credit scores in the second credit score set, respectively; and
determining the variable corresponding to a second credit score having the biggest difference from the first credit score as the key variable having the highest impact on the first credit score.

8. The method according to claim 7, further comprising: when the differences obtained by subtracting the first credit score from the each of the second credit scores in the second credit score set, respectively, are all smaller than zero, outputting a preset message to a user corresponding to the first sample, the preset message prompting that a credit risk of the user is controllable.

9. A method according to claim 4, further comprising:
outputting a message corresponding to the key variable to a user corresponding to the first sample as a guide for credit improvement.

10. The method according to claim 9, wherein the outputting a message corresponding to the key variable to a user corresponding to the first sample as a guide for credit improvement comprises:
determining whether the key variable is a behavioral variable; and
if the key variable is a behavioral variable, outputting information of a behavior corresponding to the key variable to the user corresponding to the first sample as a behavior guide.

11. A device for guiding credit improvement, the device comprising: one or more processors and one or more non-transitory computer-readable memories coupled to the one or more processors and configured with instructions executable by the one or more processors to cause the device to perform operations comprising:
inputting a first sample into a credit evaluation model to obtain a first credit score, wherein the first sample comprises a plurality of variables;
for each of the variables in the first sample, replacing a value of the variable with a threshold corresponding to the variable to obtain a second sample;
inputting the second samples into the credit evaluation model, respectively, to obtain a second credit score set comprising a plurality of second credit scores; and
determining, from the plurality of variables, a key variable having the highest impact on the first credit score based on a difference between the first credit score and each of the second credit scores in the second credit score set.

12. The device according to claim 11, wherein the threshold represents a mean, median, or mode of values of its corresponding variable from a target group of users.

13. The device according to claim 11, wherein the operations further comprise:
if the first example comprises a plurality of behavioral variables corresponding to the same behavior, replacing the values of the plurality of behavioral variables with the thresholds respectively corresponding to the plurality of behavioral variables to obtain a second sample having the values of the plurality of behavioral variables replaced.

14. The device according to claim 11, wherein the determining, from the plurality of variables, a key variable having the highest impact on the first credit score based on a difference between the first credit score and each of the second credit scores in the second credit score set comprises:
calculating the differences by subtracting the first credit score from the each of the second credit scores in the second credit score set, respectively; and
determining the variable corresponding to a second credit score having the biggest difference from the first credit score as the key variable having the highest impact on the first credit score.

15. The device according to claim 14, wherein the operations further comprise:
when the differences obtained by subtracting the first credit score from the each of the second credit scores in the second credit score set, respectively, are all smaller than zero, outputting a preset message to a user corresponding to the first sample, the preset message prompting that a credit risk of the user is controllable.

16. The device according to claim 11, wherein the operations further comprises:
outputting a meaning corresponding to the key variable to a user corresponding to the first sample as a guide for credit improvement.

17. The device according to claim 16, wherein the outputting a meaning corresponding to the key variable to a user corresponding to the first sample as a guide for credit improvement comprises:
determining whether the key variable is a behavioral variable; and
if the key variable is a behavioral variable, outputting information of a behavior corresponding to the key variable to the user corresponding to the first sample as a behavior guide.
